(19) United States
(12) Patent Application Publication
(10) Pub. No.: US 2025/0265516 A1
(43) Pub. Date: Aug. 21, 2025

(54) SYSTEM AND METHOD FOR MANAGING EVENT ALLOCATION

(71) Applicant: JUGL, Frisco, TX (US)

(72) Inventors: Arun Prasad Jaganathan, Prosper, TX (US); Arun Kumar Ponnusamy, Frisco, TX (US)

(21) Appl. No.: 18/581,412

(22) Filed: Feb. 20, 2024

(51) Int. Cl. G06Q 10/0631

(52) U.S. Cl. CPC G06Q 10/063112

(57) ABSTRACT

A method for managing event allocation is described. The method comprises obtaining data pertaining to the event. Attributes associated with the event are extracted. A resource requirement for completion of the event is determined using attributes and metadata of the user. Details related to external factors are obtained. Allocation of the event is optimized based on the attributes, the metadata, and the details related to the external factors. A hierarchical structure of the event is generated based on the optimized allocation of the event. The hierarchical structure indicates planning of a day for each worker. The event is assigned to the employees based on the hierarchical structure. Details of the assigned event are provided to the employees.

### FIELD OF THE INVENTION

The present invention relates to the field of event management, and particularly to Artificial-Intelligence (AI) based system and method for optimization of event allocation.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Event management systems allow an entity, such as a business, academic, government or other organization to create events, assign the events to other their employees or other workers, and track event completion for those tasks assigned to or by the entity. Users may be able to set the completion status (percentage, milestone, etc.), start and due dates, status (on hold, in progress, etc.), priority, or other attributes of each event.

However, such systems lack a way to manage events within a larger framework. In order for a set of events to be connected to an overall function, workflow or business object such as processing a purchase order, entities might have to create multiple events and indicate that each event is part of the larger function. Similarly, when one phase of a process or function is complete, an entity may have to manually create events associated with the next phase. Further, these systems may not provide for a dynamic schedule of the event for individual or a group of employees. For example, a way for the tasks themselves to move through different stages, be assigned to or managed by different users, etc., where changes in the underlying business objects or processes affect the state of related tasks.

Further, the entities may outsource the events to online labor around the globe and individuals to complete a large amount of events in a time efficient manner. However, given the variability in labor pool, education level, age group, the results of the completed events are frequently less than ideal.

As explained heretofore, conventional event management systems does not provide a dynamic structure or hierarchy of the event. Thus, there is a need for methods and systems to manage event in such a way as to provide close synchronization between the events, the actions performed by users, and the business objects to which the tasks relate.

### SUMMARY OF THE INVENTION

The present invention relates to a system and a method for managing event allocation.

According to an embodiment of the present disclosure, a method for managing event allocation is described. The method comprises obtaining data related to a set of events to be performed. One or more attributes associated with the event are extracted from data related to the event. Metadata related to each worker is obtained. The metadata comprises availability of each worker of the plurality of workers, a location of each worker, a strength of each worker, and personal details of each worker. A resource requirement for completion of each event of the set of events is determined based on the one or more attributes associated with each event and the metadata related to each worker. The resource requirement indicates a skill required for performing a corresponding event of the set of events, a number of workers required for performing the corresponding event, a time period required for completion of the set of events, and a tentative data for completion of the set of events. Details related to external factors that affect the completion of the set of events are obtained. Allocation of the set of events is optimized based on the one or more attributes associated with each event, the metadata related to each worker, and the details related to the external factors. A hierarchical structure of the set of events are generated based on the optimized allocation of the set of events. The hierarchical structure indicates planning of a day for each worker. The set of events are assigned to at least one worker of the plurality of workers based on the hierarchical structure. Details related to the assigned event are provided to the at least one worker.

In an aspect, the details related to the assigned event are provided to the at least one worker through a communication channel.

In an aspect, the details of the assigned event are rendered on a graphical user interface of a user device associated with the at least one worker. The graphical user interface is configured to display a status of the assigned event.

In an aspect, the event is one of an operational event, a business event, a construction event, and a manufacturing event.

In an aspect, the data related to the set of events comprises at least one of a start date of the event, a time period allotted to the event, constraints related to the event, and a difficulty level of the event.

In an aspect, the one or more attributes are extracted from the data by parsing the data.

In an aspect, the external factors are one or more of traffic, weather conditions, supply chain disruption, political instability, natural calamities, road conditions, client availability, vehicle availability, and cost of transportation.

In an aspect, a dependency defined in the hierarchical structure is maintained.

In an aspect, the method further comprises receiving, by the data processing engine, a request for updating a scope of the set of events. The hierarchical structure is updated based on the request. The set of events are assigned to the at least one worker based on the updated hierarchical structure.

In an aspect, the details related to the assigned event include at least one of the hierarchical structure related to planning of a day for each worker, timeframes associated with the completion of each event, and a location of each event.

In an aspect, the method further comprises capturing, by the data processing engine, an attendance of each worker of the plurality of workers. A completion status of each event of the set of events is monitored. Allocation of the set of events is optimized based on the attendance of each worker and the completion status of each event.

According to an embodiment of the present disclosure, a system for managing asset allocation for an event is disclosed. The system comprises one or more data processing engines and a memory comprising instructions which, when executed on the one or more data processing engines, cause the one or more data processing engines to obtain data related to the event. One or more attributes associated with the event are extracted from data related to the event. Metadata related to each worker is obtained. The metadata comprises availability of each worker of the plurality of workers, a location of each worker, a strength of each worker, and personal details of each worker. A resource requirement for completion of each event of the set of events is determined based on the one or more attributes associated with each event and the metadata related to each worker. The resource requirement indicates a skill required for performing a corresponding event of the set of events, a number of workers required for performing the corresponding event, a time period required for completion of the set of events, and a tentative data for completion of the set of events. Details related to external factors that affect the completion of the set of events are obtained. Allocation of the set of events is optimized based on the one or more attributes associated with each event, the metadata related to each worker, and the details related to the external factors. A hierarchical structure of the set of events is generated based on the optimized allocation of the set of events. The hierarchical structure indicates planning of a day for each worker. The set of events are assigned to at least one worker of the plurality of workers based on the hierarchical structure. Details related to the assigned event are provided to the at least one worker.

In an aspect, the details related to the assigned event are provided to the at least one worker through a communication channel.

In an aspect, the details of the assigned event are rendered on a graphical user interface of a user device associated with the at least one worker. The graphical user interface is configured to display a status of the assigned event.

In an aspect, the event is one of an operational event, a business event, a construction event, and a manufacturing event.

In an aspect, the data related to the set of events comprises at least one of a start date of the event, a time period allotted to the event, constraints related to the event, and a difficulty level of the event.

In an aspect, the one or more attributes are extracted from the data by parsing the data.

In an aspect, the external factors are one or more of traffic, weather conditions, supply chain disruption, political instability, natural calamities, road conditions, client availability, vehicle availability, and cost of transportation.

In an aspect, a dependency defined in the hierarchical structure is maintained.

According to an embodiment of the present disclosure, a non-transitory computer readable medium for managing asset allocation for an event is disclosed. The non-transitory computer readable medium comprises instructions configured to cause one or more data processors to obtain data related to the event. One or more attributes associated with the event are extracted from data related to the event. Metadata related to each worker is obtained. The metadata comprises availability of each worker of the plurality of workers, a location of each worker, a strength of each worker, and personal details of each worker. A resource requirement for completion of each event of the set of events is determined based on the one or more attributes associated with each event and the metadata related to each worker. The resource requirement indicates a skill required for performing a corresponding event of the set of events, a number of workers required for performing the corresponding event, a time period required for completion of the set of events, and a tentative data for completion of the set of events. Details related to external factors that affect the completion of the set of events are obtained. Allocation of the set of events is optimized based on the one or more attributes associated with each event, the metadata related to each worker, and the details related to the external factors. A hierarchical structure of the set of events is generated based on the optimized allocation of the set of events. The hierarchical structure indicates planning of a day for each worker. The set of events are assigned to at least one worker of the plurality of workers based on the hierarchical structure. Details related to the assigned event are provided to the at least one worker.

### BRIEF DESCRIPTION OF DRAWINGS

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a simplified diagram of a computing environment, in accordance with an embodiment of the present invention;

FIG. 2 illustrates a shared database for storing metadata related to users, in accordance with an embodiment of the present invention;

FIG. 3 illustrates a simplified diagram of the data processing engine, in accordance with an embodiment of present invention;

FIG. 4 illustrates a block diagram of the AI model, according to an embodiment of the present invention;

FIGS. 5A, 5B, 6A, and 6B illustrate a user interface, according to an embodiment of the present invention;

FIG. 7 illustrates a flow chart of a method for managing asset allocation for the event, according to an embodiment of the present invention;

FIG. 8 illustrates a block diagram of an example computer system, according to an embodiment of the present invention; and

FIG. 9 illustrates an example computing environment implementing a system for managing asset allocation for the event, according to an embodiment of the present invention.

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

The term “some” as used herein is to be understood as “none or one or more than one or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments, without departing from the scope of the present disclosure.

The terminology and structure employed herein is for describing, teaching, and illuminating some embodiments and their specific features. It does not in any way limit, restrict or reduce the spirit and scope of the claims or their equivalents.

More specifically, any terms used herein such as but not limited to “includes,” “comprises,” “has,” “consists,” and grammatical variants thereof do not specify an exact limitation or restriction and certainly do not exclude the possible addition of one or more features or elements, unless otherwise stated, and furthermore must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language such as “there needs to be one or more . . . ” or “one or more element is required.”

Unless otherwise defined, all terms, and especially any technical and/or scientific terms, used herein may be taken to have the same meaning as commonly understood by one having ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not be necessarily taken as limiting factors to the attached claims. The attached claims and their legal equivalents can be realized in the context of embodiments other than the ones used as illustrative examples in the description below. Embodiments of the present invention will be described below in detail with reference to the accompanying drawings.

One or more embodiments of the present invention provide a method and a system for managing event allocation. The event may be an operational event, a business event, a construction event, or a manufacturing event. For example, the event may be a project for construction of a building. Data related to the event may be received for allocation to workers. The data related to the event includes a start date of the event, a time period allotted to the event, constraints related to the event, and/or a difficulty level of the event. The data related to the event may be utilized to extract attributes associated with each event.

Further, metadata related to the workers may be obtained. The metadata includes availability of each worker of the plurality of workers, a location of each worker, a strength of each worker, and/or personal details of each worker. The metadata related to the workers and the attributes associated with the event may be utilized to determine a resource requirement for completion of the event. The resource requirement indicates a skill required for performing a corresponding event of the set of events, a number of workers required for performing the corresponding event, a time period required for completion of the set of events, and a tentative data for completion of the set of events.

Further, details related to external factors that affect the completion of the set of events may be obtained. The external factors may include traffic, weather conditions, supply chain disruption, political instability, natural calamities, road conditions, client availability, vehicle availability, and cost of transportation. A hierarchical structure of the event may be generated based on the attributes associated with the event, the metadata related to each worker, and the details related to the external factors. The hierarchical structure may indicate a timeframe and a location to finish the set of events in the minimum possible time period.

The event may be assigned to the workers according to the hierarchical structure. Further, the details of the assigned event may be provided to the worker through a communication channel. The details of the assigned event are rendered on a Graphical User Interface (GUI) of a user device associated with the worker. The GUI is configured to display a status of the assigned event.

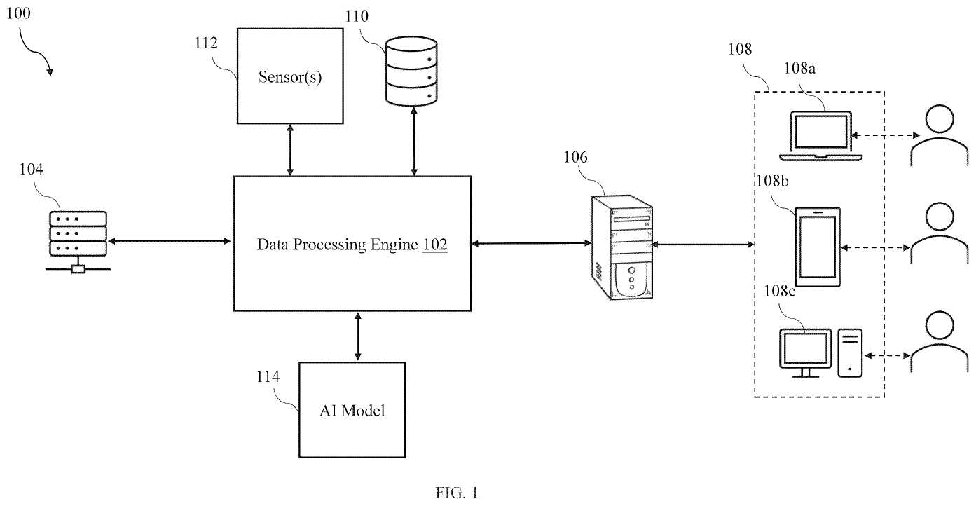

FIG. 1 illustrates a simplified diagram of a computing environment 100, in accordance with an embodiment of the present invention. The computing environment 100 comprises various computing systems (e.g., servers and devices) interconnected by a wireless or wired network (not illustrated). The network may comprise any combination of a wide area network (e.g. WAN), local area network (e.g. LAN), cellular network, wireless LAN (e.g. WLAN), or any such means for enabling communication of computing systems. The network may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol), and/or any combination of these and/or other networks.

The computing environment 100 may comprise a data processing engine 102 that obtains data related to a set of events to be performed. The data related to the event includes a start date of the event, a time period allotted to the event, constraints related to the event, and/or a difficulty level of the event. The data related to the event may be utilized to extract attributes associated with each event.

In some embodiments, the data related to the event may be received from an organizer server 104. The organizer server 104 may be implicitly or explicitly associated with the owner of an organization. The organizer server 104 may store all information associated with an organization owned by the owner. The information associated with the organization may comprise types of the event to be performed by the employee(s) of the organization along with historical data of the client's accomplished events.

The data processing engine 102 may represent any single computing system with dedicated hardware and software, multiple computing systems clustered together (e.g., a server farm), a portion of shared resources on one or more computing systems (e.g., virtual server), or any combination thereof.

The data processing engine 102 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The data processing engine 102 can include one or more virtual machines running virtual operating systems, or other computing architectures involving virtualization such as one or more flexible pools of logical storage devices that can be virtualized to maintain virtual storage devices for the server. In various embodiments, the data processing engine 102 may be adapted to run one or more services or software applications that provide the functionality described in the foregoing disclosure.

The computing systems in the data processing engine 102 may run one or more operating systems including any of those discussed above, as well as any commercially available server operating system. The data processing engine 102 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

The data related to the set of events includes a start date of the event, a time period allotted to the event, constraints related to the event, and a difficulty level of the event. The data processing engine 102 may analyze the data pertaining to the event to define scope of the event. The data related to the event may be utilized to extract attributes associated with each event.

The data processing engine 102 may obtain metadata related to the set of events from an employee data server 106. The employee data server 106 may store all the details of employees. The details may include, but may not be limited to, availability of each worker of the plurality of workers, a location of each worker, a strength of each worker, and personal details of each worker.

In some embodiments, the employee data server 106 may be communicatively coupled with user devices 108 associated with a corresponding user. The employee data server 106 may fetch the data from each user device related to details of the user. In an implementation, the employee data server 106 may include a local database or an external database for storing the metadata related to the employees.

In some embodiments, the user devices 108 may represent one of a variety of other computing devices (e.g., a laptop computer 108a, a smart phone 108b, a desktop computer 108c, an IP phone, a tablet, etc.) having hardware and software (e.g. web browser application) capable of processing and displaying information (e.g., web page, graphical user interface, etc.), and communicating information (e.g., web page request, user activity, campaign settings, etc.) over the network.

The user devices 108 may include various types of computing systems such as PA devices, portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX© or UNIX-like operating systems, Linux or Linux-like operating systems such as Google Chrome™ OS) including various mobile operating systems (e.g., Microsoft Windows Mobile*, iOS®, Windows Phone®, Android™, BlackBerry®, Palm OS©). Portable handheld devices may include cellular phones, smartphones, (e.g., an iPhone®), tablets (e.g., iPad®), personal digital assistants (PDAs), and the like. Wearable devices may include Google Glass© head mounted display, and other devices. Gaming systems may include various handheld gaming devices, internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

In some embodiments, the data processing engine 102 may determine a resource requirement for completion of the event based on the one or more attributes associated with each event and the metadata related to each worker. The resource requirement may indicate a skill required for performing a corresponding event of the set of events, a number of workers required for performing the corresponding event, a time period required for completion of the set of events, and a tentative data for completion of the set of events. For example, in a case, the attribute of the event indicates that the event needs 50 hours for completion, and it should be completed within 5 days. In such case, if the metadata of the employees indicates that an employee can work for 5 hours in a day, the data processing engine 102 determines that the event should be allocated to 2 employees per day for 5 days.

The data processing engine 102 may obtain details related to external factors that affect the completion of the event. Such details may be obtained from a storage system 110 that stores environmental conditions. The external factors may include traffic, weather conditions, supply chain disruption, political instability, natural calamities, road conditions, client availability, vehicle availability, and cost of transportation. The storage system 110 may be a server, a temporary memory, etc. The storage system 110 may be communicatively connected to different servers through a network for fetching real time environmental conditions.

In some embodiments, the data processing engine 102 may obtain the details related to the external factors from one or more sensors 112. The sensor 112 may be a temperature sensor, a pressure sensor, a position sensor, etc. The sensor 112 may detect the external factor, such as a temperature in surrounding, a humidity in surrounding, etc.

The data processing engine 102 utilizes an Artificial Intelligence (AI) model 114 to optimize allocation of the event. The allocation of the event may be optimized based on the one or more attributes associated with each event, the metadata related to each worker, and the details related to the external factors. The AI model 114 may be trained on training dataset related to optimization of the allocation of the event.

In some embodiments, the AI model 114 may further generate a hierarchical structure of the event based on the optimized allocation of the set of events. The hierarchical structure may relate to a timeframe and a location to finish the set of events in the minimum possible time period.

Further, the data processing engine 102 may assign the event to one or more employee based on the hierarchical structure. For example, each task of the event may be assigned to a suitable employee based on their metadata. In such a way, the completion time is minimized.

Post assigning the event to the corresponding employee, the details related to the assigned event may be provided to the corresponding employee. The details may be provided through the user device 108 associated with the employee. In some embodiments, the user device 108 may include a screen on which a user interface may be displayed to render the details related to the event.

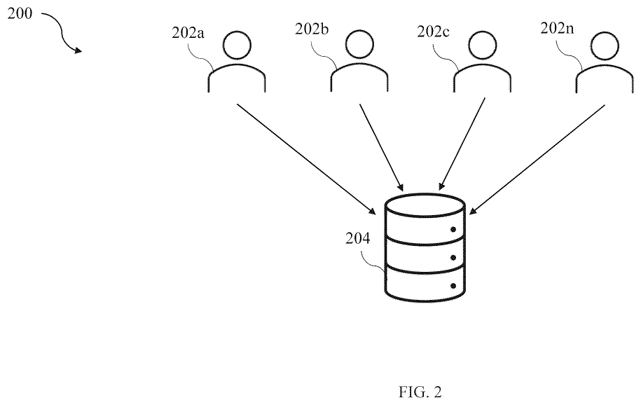

FIG. 2 illustrates a shared database for storing metadata related to users, in accordance with an embodiment of the present invention. An organization may have multiple employees. Each employee has a specific metadata, such as skillset of the employee, availability of the employee, working condition of the employee, compensation of the employee, experience of the employee, location of the employee, leave details of the employee, strength/weakness of the employee, etc. Thus, each employee has their own capacity to execute the event.

As illustrated in FIG. 2, the organization may have employees, such as 202a, 202b, 202c, so on and 202d. Each employee 202 of the organization may correspond to a unique metadata. The unique metadata of each employee 202 may be stored in a shared database 204. The shared database 204 may be present internally or externally to the system.

The shared database 204 may include one or more non-transitory memory devices, including volatile and non-volatile memory devices. The shared database 204 is shown to be depicting, the system memory and the computer-readable storage media. The shared database 204 may include a number of memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system, such as during start-up, may typically be stored in the ROM. The RAM typically contains data and/or program modules that are presently being operated and executed by processing subsystem. In some implementations, the shared database 204 may include multiple different types of memory, such as static random-access memory (SRAM), dynamic random-access memory (DRAM), and the like.

The metadata stored in the shared database 204 may be utilized for optimizing the allocation of the event in order to minimize the completion time of the event. Further, the optimized allocation of the event may be utilized to generate a hierarchical structure of the event.

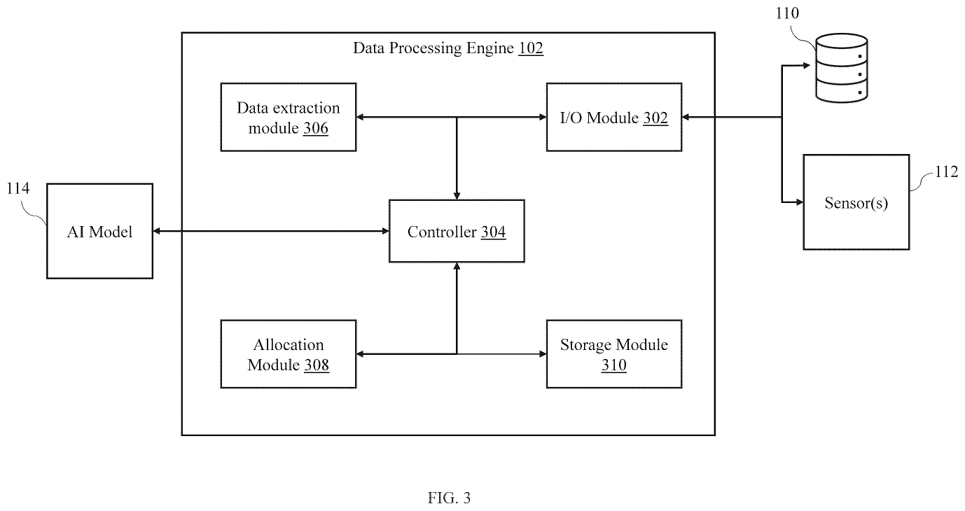

FIG. 3 illustrates a simplified diagram of the data processing engine 102, in accordance with an embodiment of present invention. The data processing engine 102 may comprise an Input/Output (I/O) module 302, a controller 304, a data extraction module 306, an allocation module 308, and a storage module 310. It should be understood that all the modules of the data processing engine 102 are communicatively coupled with each other.

The I/O module 302 may obtain details related to external factors that affect the completion of the event from the storage system 110 and/or the sensor 112. In an implementation, the I/O module 302 may fetch the data from each user device related to details of the user. In another implementation, the I/O module 302 may obtain data related to the event.

The I/O module 302 is communicatively coupled with external devices, such as the storage system 110, the sensor 112, the employee data server 106, and the organizer server. The I/O module 302 may be responsible for obtaining all the external data from various entities.

The controller 304 may acquire the above-mentioned data from the I/O module 302 and may analyze the data for further processing. In some embodiments, the controller 304 may optimize the allocation of the event to the employees.

The data extraction module 306 may extract one or more attributes associated with the event from the data related to the event. The data extraction module 306 may parse through the data related to the event to identify the attributes of the event.

The controller 306 may utilize the AI model 114 to optimize the allocation of the event in order to minimize the completion time of the event. The allocation of the event may be optimized based on one or more attributes associated with each event, the metadata related to each worker, and the details related to the external factors.

The controller 306 may further utilize the AI model 114 to generate a hierarchical structure of the event. The hierarchical structure may relate to a timeframe and a location to finish the set of events in the minimum possible time period.

The allocation module 308 may assign the event to at least one employee based on the hierarchical structure. For example, each task of the event may be assigned to a suitable employee based on their metadata. In such a way, the completion time is minimized.

The storage module 310 may store all the relevant data temporarily or permanently for the purpose of processing. For example, the storage module 310 may store training data and testing data associated with the AI model 114. In addition, the storage module 310 may store program instruction to be executed by the controller 304.

The storage module 310 may include one or more non-transitory memory devices, including volatile and non-volatile memory devices. The storage module 310 is shown to be depicting, the system memory and the computer-readable storage media. The storage module 310 may include a number of memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system, such as during start-up, may typically be stored in the ROM. The RAM typically contains data and/or program modules that are presently being operated and executed by processing subsystem. In some implementations, the storage module 310 may include multiple different types of memory, such as static random-access memory (SRAM), dynamic random-access memory (DRAM), and the like.

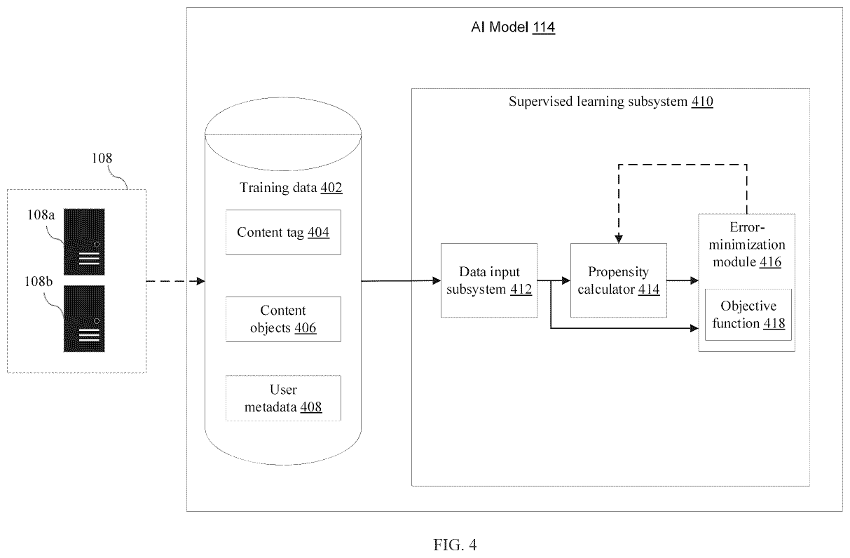

FIG. 4 illustrates a block diagram of the AI model 114, according to an embodiment of the present invention. More specifically, in some embodiments, The AI model 114 may be trained using training data 402. The training data 402 may be populated by data received from the multiple media sources, such as user devices 108. The AI model 114 may be or include a non-binary classifier, such as a multinomial logistic regression model implemented in a neural network, trained to predict a probability that an input can be mapped to one or more classes of a set of classes, corresponding to content tags 404 or user characteristics from user metadata 408. As such, training the AI model 114 may include applying a supervised learning technique using one or more labeled sets of training data 402, which may include content tags 404, content objects 406, and user metadata 408. The user metadata 408 may include data related to the vendee and/or the vendor. The content objects 406 may comprise data related to all the events accomplished by the vendee. The content tags 404 may be drawn from a database of features that the feature prediction models are trained to identify. As such, the content tags 404 may correspond to the features that may characterize content objects processed by the AI model 114.

The training data may be provided to a supervised learning subsystem 410. For example, the supervised learning subsystem 410 may comprise a data input subsystem 412 to receive the training data 402. As part of supervised training, the supervised learning subsystem 410 may use the training data 402 to define a ground truth, such that elements defining a mapping of the content tags 404 and user characteristics from the user metadata 408 are provided to a propensity calculator 414 and an error minimization module 416. The error minimization module 416 may, in turn, implement an objective function 418, which may be an error function, for example, defined as a distance between the model output and the ground truth. In this way, training may include adjusting one or more weights and/or coefficients of the propensity calculator 414 over multiple iterations until the value of the objective function converges to a global minimum.

In some embodiments, the input to the propensity calculator 414 includes the characteristics of a set of users, and the output includes a vector of probability values corresponding to predicted content features. In this way, the propensity calculator 414 may be trained to map the content tags 404 of the training data 402 to the user metadata 408 of the training data 402, and, once trained, the propensity calculator 414 may be used to generate the propensity score. As trained, the propensity calculator may be able to determine the propensity score indicative of the extent to which the user has propensity for releasing user's data to at least one digital platform.

In some embodiments, the supervised learning subsystem 410 may implement hyperparametric tuning, in addition to supervised learning, to optimize the AI model 114. For example, one or more terms of the objective function 418 and/or the AI model 114 may be fine-tuned by varying parameters that are not learned, such as scalar weighting factors.

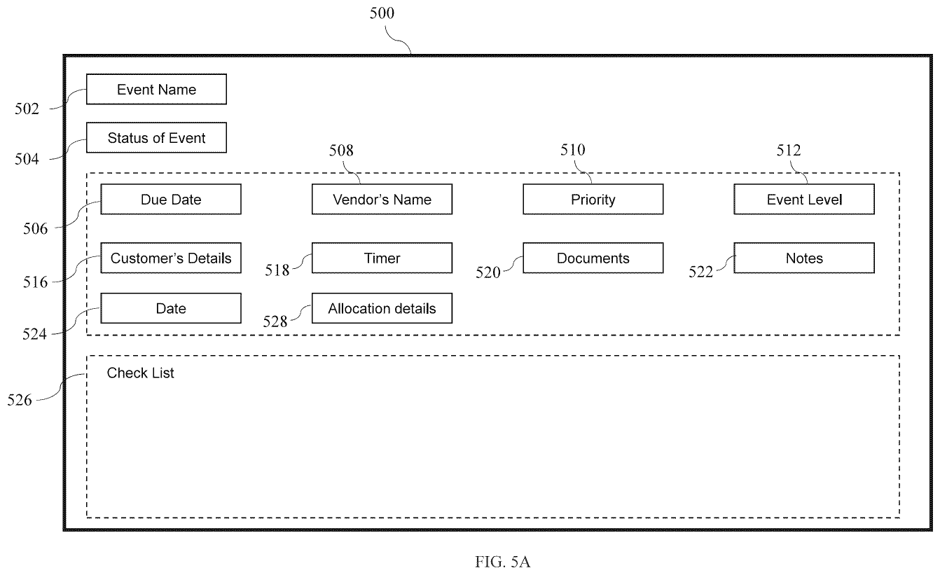

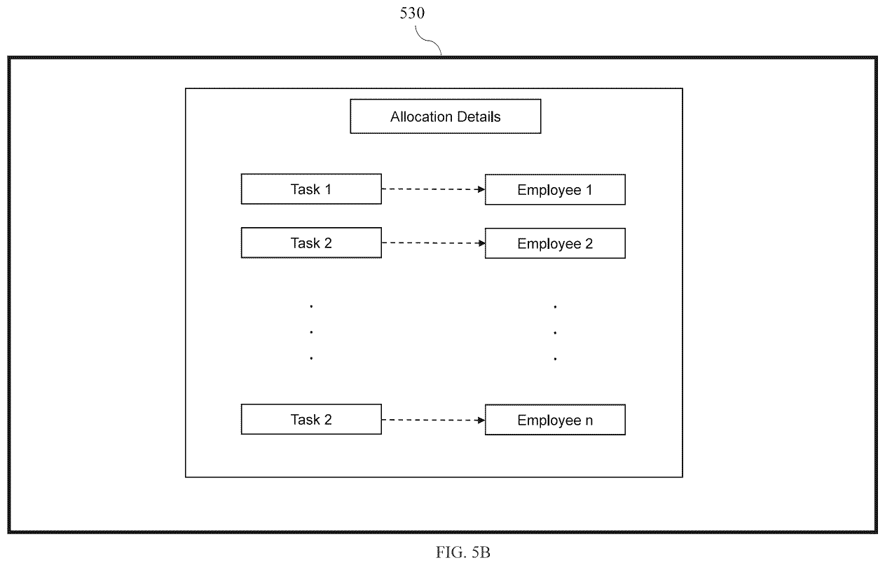

FIG. 5A illustrates a user interface 500, according to an embodiment of the present invention. The user interface 500 may be displayed on the user device associated with the vendee and/or the vendor. The user interface 500 may include multiple elements indicating distinct items. For example, as illustrated in FIG. 5, the user interface 500 includes an element, 502, an element 504, an element 506, an element 508, an element 510, an element 512, an element 514, an element 516, an element 518, an element 520, an element 522, an element 524, and an element 526.

The element 502 may indicate a name of the event. For example, the name of the event may be “Building a Car Factory”. The element 504 may indicate a status of the event. For example, the status of the event may be one of, completed, pending, active, suspended, etc. The status of the event may be updated dynamically based on completion of the tasks associated with the event.

The element 506 may indicate a due date of the event. The due date may be one of a tentative date for completion of the event, a client commented deadline of the event, a statutory deadline assigned by a third party, etc. The element 508 may indicate name of a vendor. The event may be assigned to the vendor. The vendor may be an employee of the organization, a third-party organization, etc. The element 510 may indicate a priority of the event. The element 512 may indicate a level of the event. For example, the level of the event may include an easy level, a hard level, and a medium level.

The element 516 may indicate details of a customer associated with the event. In an example, the customer may be client of an organization. The element 518 may indicate a timer associated with the progress of the event. The timer may be synchronized with the event and may be dynamically updated during the progress of the event. The element 520 may comprise documents related to the event. For example, the documents comprise, but are not limited to, a contract executed between the vendor and the vendee. The notes may comprise additional notes provided by the vendor and/or the vendee.

The element 524 may indicate a current date. The element 526 may indicate a check list related to the event. The check list may include all related details updated by the vendor and/or the vendee. For example, the vendor and/or the vendee may update all the information dynamically.

The element 528 may indicate details of the allocation of the event. For example, the element 528 indicates an optimized allocation of each task of the event to a corresponding employee. For optimization of the allocation of the employees, the processor may fetch the metadata related to all employees and may map each task of the event to a suitable employee.

FIG. 5B illustrates a user interface 530, according to an embodiment of the present invention. When a user clicks on the element 528, illustrated in FIG. 5A, the user interface 530 may be displayed on the screen of the user device. The user interface 530 may include details of allocation of the event.

Each task of the event may be assigned to a suitable employee from the organization. The task may be assigned based on the hierarchical structure determined by the AL model. As illustrated in FIG. 5B, task 1 of the event is assigned to the first employee, task 2 of the event is assigned to the second employee, so on and task 3 of the event is assigned to the third employee.

In some embodiments, the tasks of the event may be assigned based on the metadata related to each employee. The metadata related to the employee may include, but are not limited to, skillset of the employee, availability of the employee, working condition of the employee, compensation of the employee, experience of the employee, location of the employee, leave details of the employee, strength/weakness of the employee, etc.

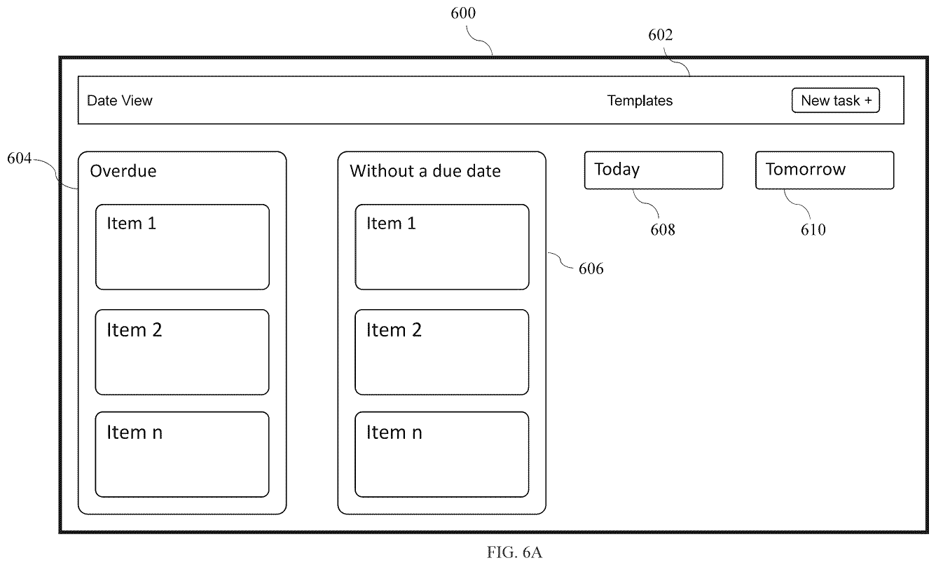

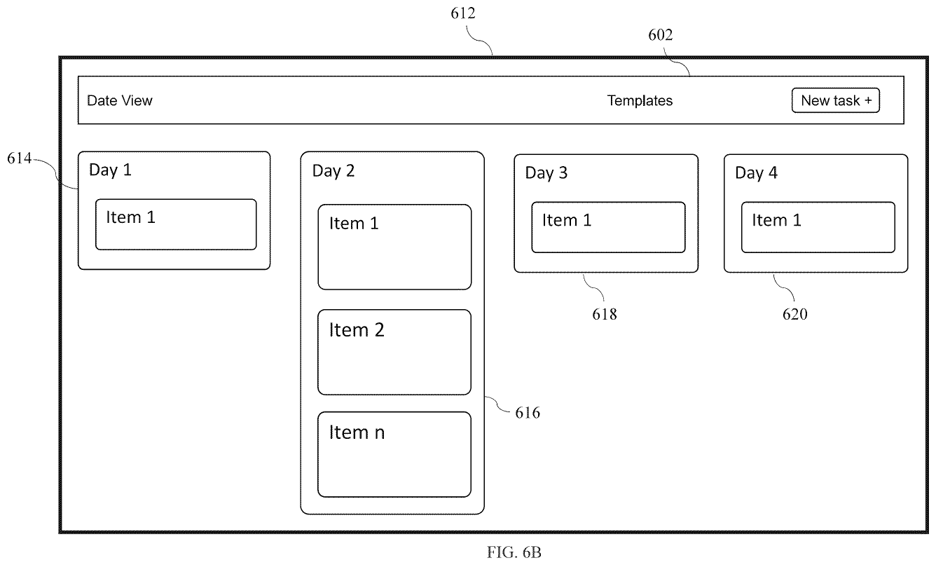

FIG. 6A illustrates a user interface 600, according to an embodiment of the present invention. The user interface 600 may be displayed on the user device associated with the vendee and/or the vendor. The user interface 600 may include multiple elements indicating distinct items. For example, as illustrated in FIG. 6, the user interface 600 includes an element, 602, an element 604, an element 606, an element 608, and an element 610.

The element 602 may indicate a heading of the user interface 600. For example, the element 602 may include a date view tab and an option of new task. When the user clicks on the new task tab, another user interface pops up on the screen to configure the task.

The element 604 may include a list of items which are overdue from the date of delivery. For example, if a task named “complete concrete paving for laying parking lot” is not completed within the time allocated for the task, it appears within the overdue tab. Such items are treated as urgent tasks. Thus, these tasks are then assigned to employees who are very efficient.

The element 606 may indicate a list of items which do not have any due date. Such items are treated as trivial. These tasks are then assigned to employees how are not very efficient.

The element 608 may indicate tasks assigned for today and the element 610 may indicate tasks assigned for tomorrow. In some embodiments, the details of elements 604, 606, 608, and 610 may be updated dynamically based on the attributes associated with each event, the metadata related to each worker, and the details related to the external factors.

FIG. 6B illustrates a user interface 612, according to an embodiment of the present invention. The user interface 612 may be displayed on the screen of the user device. The user interface 600 may include multiple elements indicating distinct items. For example, as illustrated in FIG. 6B, the user interface 612 includes an element, 614, an element 616, an element 618, and an element 620. The user interface 612 shows the hierarchical structure of the events.

The element 614 may indicated the tasks assigned for the first day. The element 616 may indicate the tasks assigned for the second day. The element 618 may indicate the tasks assigned for the third day. The element 620 may indicate the tasks assigned for the fourth day.

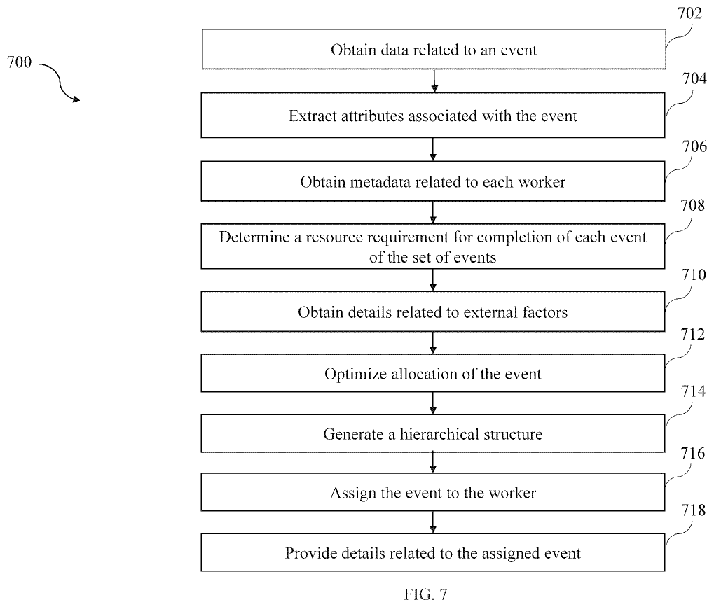

FIG. 7 illustrates a flow chart 700 of a method for managing event allocation for the event, according to an embodiment of the present invention. The method starts with step 702. At step 702, the data processing engine obtains data related to the event. The event is one of an operational event, a business event, a construction event, and a manufacturing event. The data related to the set of events may include at least one of the start date of the event, a time period allotted to the event, constraints related to the event, and a difficulty level of the event.

At step 704, the data processing engine may extract one or more attributes associated with the event from the data related to the set of events. The one or more attributes are extracted from the data by parsing the data.

At step 706, the data processing engine may obtain metadata related to each worker of a plurality of workers. The metadata may includes availability of each worker of the plurality of workers, a location of each worker, a strength of each worker, and personal details of each worker.

At step 708, the data processing engine may determine a resource requirement for completion of the event. The resource requirement may be determined based on the one or more attributes associated with each event and the metadata related to each worker. The resource requirement indicates a skill required for performing a corresponding event of the set of events, a number of workers required for performing the corresponding event, a time period required for completion of the set of events, and a tentative data for completion of the set of events.

At step 710, the data processing engine extracts details related to external factors that affect the completion of the set of events. The external factors are one or more of traffic, weather conditions, supply chain disruption, political instability, natural calamities, road conditions, client availability, vehicle availability, and cost of transportation.

At step 712, the AI model associated with the data processing engine may optimize allocation of the set of events. The optimization may be performed based on the one or more attributes associated with each event, the metadata related to each worker, and the details related to the external factors.

At step 714, the AI model may generate a hierarchical structure of the event. The hierarchical structure may be generated based on the optimized allocation of the set of events. The hierarchical structure relates to a timeframe and a location to finish the set of events in the minimum possible time period. A dependency defined in the hierarchical structure may be maintained.

At step 716, the data processing engine may assign the event to the employees based on the hierarchical structure. The assignment may be performed such that a suitable employee should be assigned with the corresponding task of the event.

At step 718, the data processing engine details related to the assigned event may be provided to the corresponding employee. The details related to the assigned event include at least one of the hierarchical structure of the set of events, timeframes associated with the completion of each event, and a location of each event.

The details related to the assigned event are provided to at least one worker through a communication channel. The details of the assigned event are rendered on a graphical user interface of a user device associated with at least one worker. The graphical user interface is configured to display the status of the assigned event.

In some embodiments, the data processing engine receives a request for updating a scope of the event. In response to the request, the data processing engine may update the hierarchical structure and may assign the event to the employees based on the request.

The data processing engine may capture an attendance of each employee. The captured attendance may be utilized to monitor a completion status of the event. In response to the monitoring, the data processing engine may allocate the event to the employee based on the attendance of the employee and the completion status of the event.

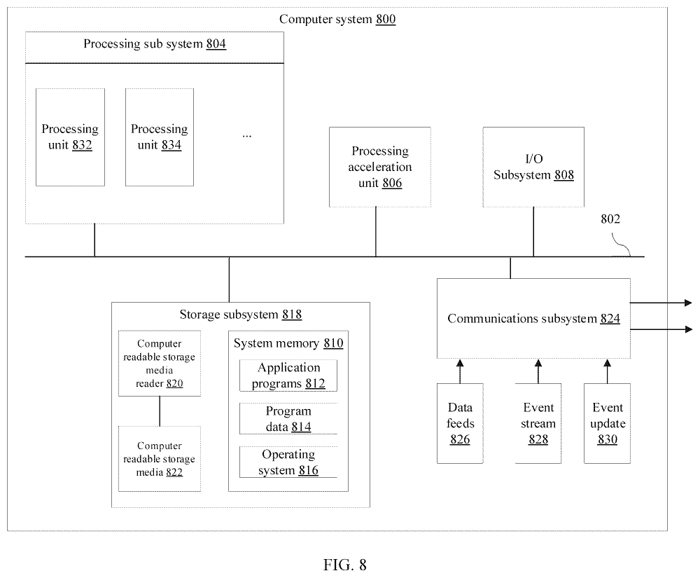

FIG. 8 illustrates a block diagram of an example computer system 800, according to an embodiment of the present invention. For example, in some embodiments, the computer system 800 may be used to implement any of systems, subsystems, and components described herein. For example, multiple host machines may provide and implement processes of a computing environment 100 as described herein. Computer systems such as computer system 800 may be used as host machines. As shown in FIG. 8, the computer system 800 includes various subsystems including a processing subsystem 804 that communicates with a number of other subsystems via a bus subsystem 802. These other subsystems may include a processing acceleration unit 806, an I/O subsystem 808, a storage subsystem 818, and a communications subsystem 824. The storage subsystem 818 may include non-transitory computer-readable storage media including a computer-readable storage media 822 and a system memory 810.

Bus subsystem 802 provides a mechanism for letting the various components and subsystems of computer system 800 communicate with each other as intended. Although bus subsystem 802 is shown schematically as a single bus, alternative embodiments of the bus subsystem may utilize multiple buses. The subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 804 controls the operation of the computer system 800 and may comprise one or more processors, application specific integrated circuits (ASICs), or field programmable gate arrays (FPGAs). The processors may include be single core or multicore processors. The processing resources of the computer system 800 can be organized into one or more processing units 832, 834, etc. A processing unit may include one or more processors, one or more cores from the same or different processors, a combination of cores and processors, or other combinations of cores and processors. In some embodiments, processing subsystem 804 can include one or more special purpose co-processors such as graphics processors, digital signal processors (DSPs), or the like. In some embodiments, some or all of the processing units of processing subsystem 804 can be implemented using customized circuits, such as application specific integrated circuits (ASICs), or field programmable gate arrays (FPGAs).

In some embodiments, the processing units in processing subsystem 804 can execute instructions stored in system memory 810 or on the computer-readable storage media 822. In various embodiments, the processing units can execute a variety of programs or code instructions and can maintain multiple concurrently executing programs or processes. At any given time, some or all of the program code to be executed can be resident in system memory 810 and/or on the computer-readable storage media 822 including potentially on one or more storage devices. Through suitable programming, processing subsystem 804 can provide various functionalities described above. In instances where computer system 800 is executing one or more virtual machines, one or more processing units may be allocated to each virtual machine.

In certain embodiments, a processing acceleration unit 806 may optionally be provided for performing customized processing or for off-loading some of the processing performed by processing subsystem 804 so as to accelerate the overall processing performed by computer system 800.

The I/O subsystem 808 may include devices and mechanisms for inputting information to the computer system 800 and/or for outputting information from or via the computer system 800. In general, use of the term input device is intended to include all possible types of devices and mechanisms for inputting information to the computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass© blink detector that detects eye activity (e.g., “blinking” while taking pictures and/or making a menu selection) from users and transforms the eye gestures as inputs to an input device (e.g., Google Glass©). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 800 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

The storage subsystem 818 provides a repository or data store for storing information and data that is used by computer system 800. The storage subsystem 818 provides a tangible non-transitory computer-readable storage medium for storing the basic programming and data constructs that provide the functionality of some embodiments. The storage subsystem 818 may store software (e.g., programs, code modules, instructions) that when executed by processing subsystem 804 provides the functionality described above. The software may be executed by one or more processing units of processing subsystem 804. The storage subsystem 818 may also provide a repository for storing data used in accordance with the teachings of this disclosure.

The storage subsystem 818 may include one or more non-transitory memory devices, including volatile and non-volatile memory devices. The storage subsystem 818 is shown to be depicting, the system memory 810 and the computer-readable storage media 822, in FIG. 8. The system memory 810 may include a number of memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within the computer system 800, such as during start-up, may typically be stored in the ROM. The RAM typically contains data and/or program modules that are presently being operated and executed by processing subsystem 804. In some implementations, system memory 810 may include multiple different types of memory, such as static random-access memory (SRAM), dynamic random-access memory (DRAM), and the like.

By way of example, and not limitation, as depicted in FIG. 7, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome© OS, and the like) and/or mobile operating systems such as iOS, Windows© Phone, Android© OS, BlackBerry® OS, Palm® OS operating systems, and others.

In certain embodiments, software instructions or code implementing the computing environment 100, as described herein, may be executed in system memory 810.

Computer-readable storage media 822 may store programming and data constructs that provide the functionality of some embodiments. Computer-readable storage media 822 may provide storage of computer-readable instructions, data structures, program modules, and other data for computer system 800. Software (programs, code modules, instructions) that, when executed by processing subsystem 804 provides the functionality described above, may be stored in the storage subsystem 818. By way of example, computer-readable storage media 822 may include non-volatile memory such as a hard disk drive, a magnetic disk drive, an optical disk drive such as a CD ROM, DVD, a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs.

In certain embodiments, the storage subsystem 818 may also include a computer-readable storage media reader 820 that can further be connected to computer-readable storage media 822. Reader 820 may receive and be configured to read data from a memory device such as a disk, a flash drive, etc.

In certain embodiments, computer system 800 may support virtualization technologies, including but not limited to virtualization of processing and memory resources. For example, computer system 800 may provide support for executing one or more virtual machines. In certain embodiments, computer system 800 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices.

Communication subsystem 824 may support both wired and/or wireless communication protocols. For example, in certain embodiments, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments communications subsystem 824 can provide wired network connectivity (e.g., Ethernet) in addition to or instead of a wireless interface.

Communication subsystem 824 can receive and transmit data in various forms. For example, in some embodiments, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain embodiments, the communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

The communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

The computer system 800 can be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 800 depicted in FIG. 7 is intended only as a specific example. Many other configurations having more or fewer components than the system depicted in FIG. 8 are possible. Based on the disclosure and teachings provided herein, a person of ordinary skill in the art will appreciate other ways and/or methods to implement the various embodiments.

The embodiments disclosed herein can be implemented through at least one software program running on at least one hardware device and performing network management functions to control the elements. The elements shown in FIG. 78 include blocks which can be at least one of a hardware device, or a combination of hardware device and software module.

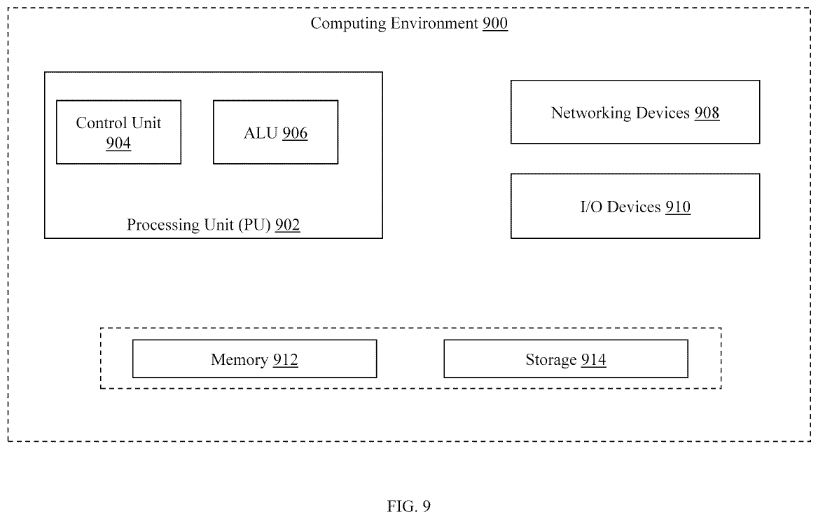

FIG. 9 illustrates an example computing environment implementing a system for managing event allocation, according to an embodiment of the present invention. As depicted in FIG. 9, the computing environment 900 (similar to the computing environment 100) comprises at least one processing unit 902 that is equipped with a control unit 904 and an Arithmetic Logic Unit (ALU) 906, a plurality of networking devices 908 and a plurality Input output, I/O devices 910, a memory 912, and a storage 914. The processing unit 902 may be responsible for implementing the method described in FIG. 7. For example, the processing unit 902 may in some embodiments be equivalent to the processor of the computing environment 100 described above in conjunction with the FIGS. 1-7. The processing unit 902 is capable of executing software instructions stored in memory 912. The processing unit 902 receives commands from the control unit 904 in order to perform its processing. Further, any logical and arithmetic operations involved in the execution of the instructions are computed with the help of the ALU 906.

The computer program is loadable into the processing unit 902, which may, for example, be comprised in an electronic apparatus. When loaded into the processing unit 902, the computer program may be stored in the memory 912 associated with or comprised in the processing unit 902. According to some embodiments, the computer program may, when loaded into and run by the processing unit 902, cause execution of method steps according to, for example, any of the methods illustrated in FIG. 7 or otherwise described herein.

The overall computing environment 900 may be composed of multiple homogeneous and/or heterogeneous cores, multiple CPUs of different kinds, special media and other accelerators. Further, the plurality of processing unit 902 may be located on a single chip or over multiple chips.

The algorithm comprising of instructions and codes required for the implementation are stored in either the memory 912 or the storage or both. At the time of execution, the instructions may be fetched from the corresponding memory 912 and/or storage, and executed by the processing unit 902.

In case of any hardware implementations various networking devices 908 or external I/O devices 910 may be connected to the computing environment to support the implementation through the networking devices 908 and the I/O devices 910.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user's computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer-readable media such as RAMs, ROMs, flash memory, EEPROMs, optical devices (CD or DVD), hard drives, and floppy drives, or any suitable device. The computer-executable component can be a processor but any suitable dedicated hardware device can (alternatively or additionally) execute the instructions.

As a person skilled in the art will recognize from the previous detailed description and the figures and claims, modifications and changes can be made to the embodiments of the invention without departing from the spirit and scope of this invention.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible.

What is claimed is:

1. A method for managing event allocation, comprising:
acquiring, by a data processing engine, data related to a set of events to be performed from a first server;
identifying, by the data processing engine, one or more attributes associated with each event of the set of events from the data related to the set of events;
acquiring, by the data processing engine, via a plurality of terminal devices associated to a plurality of workers, metadata related to each worker of the plurality of workers, wherein
the metadata comprises availability of each worker of the plurality of workers, a location of each worker, a strength of each worker, and personal details of each worker,
the data processing engine is communicatively coupled to the first server, a second server, the plurality of terminal devices, an Artificial Intelligence (AI) model and at least one sensor,
each of the event includes one of an operational event, a business event, a construction event, or a manufacturing event, and
the AI model is trained for one of an operational event allocation, a business event allocation, a construction event allocation, or a manufacturing event allocation, via a supervised learning process, based at least on training data and first information that are received from at least one of the second server and a set of terminal devices of the plurality of terminal devices, wherein the supervised learning process comprises:
receiving, by the AI model, the training data and the first information, for evaluation from the at least one of the second server and the set of terminal devices, wherein the training data and the first information comprises pre-identified data and unidentified data;
segregating, by the data processing engine, the training data to at least one of content tags, content objects, and the metadata, wherein the unidentified data at least corresponds to the content tags, and the pre-identified data at least corresponds to the content objects and the metadata;
evaluating, invariably, by a propensity calculator of the AI model, the unidentified data for identifying the content tags, based on the pre-identified data;
executing, by an error-minimization module of the AI model, an objective function to compute a degree of error in the identifying the content tags, wherein the propensity calculator outputs data, the error-minimization module receives the output data from the propensity calculator and the training data for executing the objective function, and the error-minimization module outputs second information related to the degree of error to the propensity calculator as feedback; and
changing, invariably, by the AI model, at least a coefficient of the propensity calculator till the degree of error in the identifying the content tags recede a value, wherein the changing of the at least the coefficient of the propensity calculator is based on the feedback from the error-minimization module, and the value is based on the changing of the at least the coefficient of the propensity calculator to minimize the degree of error;
optimizing, by the AI model, the trained AI model, in addition to the supervised learning process, by implementing a machine-readable set of instructions that corresponds to hyperparametric tuning;
determining, by the data processing engine, a resource requirement for completion of each event of the set of events based on the one or more attributes associated with each event and the metadata related to each worker, wherein the resource requirement indicates a skill required for performing a corresponding event of the set of events, a number of workers required for performing the corresponding event, a time period required for the completion of the set of events, and a tentative date for the completion of the set of events;
acquiring, by the data processing engine, via the at least one sensor, details related to external factors that affect the completion of the set of events, wherein the external factors include traffic, weather conditions, supply chain disruption, political instability, natural calamities, road conditions, client availability, vehicle availability, and cost of transportation;
optimizing, by the trained model, allocation of the set of events based on the one or more attributes associated with each event, the metadata related to each worker, and the details related to the external factors;
generating, dynamically, by the trained AI model, a hierarchical structure of the set of events based on the optimized allocation of the set of events and the details related to the external factors, wherein the hierarchical structure indicates planning of a day for each worker, timeframes associated with the completion of each event of the set of events and a location of each event of the set of events;
assigning, by the data processing engine, the set of events to at least one worker of the plurality of workers based on the hierarchical structure;
transmitting, by the data processing engine, details related to the assigned event to a terminal device of the plurality of terminal devices associated to a corresponding worker of the plurality of workers, wherein the plurality of terminal devices is configured to display the details;
receiving, by the trained AI model, a request for making changes to the set of events, wherein the supervised learning process is based on the request received for making changes to the set of events, and the first information received from the at least one of the second server and the set of terminal devices corresponds to the request received for making changes to the set of events;
updating, by the trained AI model, the hierarchical structure based on the request received for making changes to the set of events;
re-assigning, by the trained AI model, the set of events to the at least one worker based on the updated hierarchical structure;
detecting, by the trained AI model, the location of each worker of the plurality of workers;
monitoring, by the trained AI model, a completion status of each event of the set of events; and
re-optimizing, by the trained AI model, allocation of the set of events based on the re-assigning the set of events, the location of each worker, and the completion status of each event.

2. (canceled)

3. The method according to claim 1, wherein the details related to the assigned event are rendered on a graphical user interface of the terminal device associated to the corresponding worker, and the graphical user interface is configured to display a status of the assigned event.

4. (canceled)

5. The method according to claim 1, wherein the data related to the set of events comprises at least one of a start date of the event, a time period allotted to the event, constraints related to the event, and a difficulty level of the event.

6. The method according to claim 1, wherein the one or more attributes are extracted from the data by parsing the data.

7. (canceled)

8. The method according to claim 1, wherein a dependency defined in the hierarchical structure is maintained.

9. (canceled)

10. The method according to claim 1, wherein the details related to the assigned event include at least one of the hierarchical structure of the set of events, timeframes associated with the completion of each event, and a location of each event.

11. (canceled)

12. A system for managing event allocation, comprising:
a data processing engine;
an Artificial Intelligence (AI) model;
a first server configured to store data related to a set of events;
a second server configured to store a first information;
at least one sensor configured to detect details related to external factors that affect completion of the set of events, wherein the external factors include traffic, weather conditions, supply chain disruption, political instability, natural calamities, road conditions, client availability, vehicle availability, and cost of transportation
a plurality of terminal devices associated to a plurality of workers, wherein the data processing engine is communicatively coupled to each of the AI model, the first server, the second server, the at least one sensor and the plurality of terminal devices, and the data processing engine is configured to:
acquire the data related to the set of events to be performed from the first server, wherein each event of the set of events includes one of an operational event, a business event, a construction event, or a manufacturing event;
identify one or more attributes associated with each event of the set of events from the data related to the set of events;
acquire metadata related to each worker of the plurality of workers from the plurality of terminal devices, wherein
the metadata comprises availability of each worker of the plurality of workers, a location of each worker, a strength of each worker, and personal details of each worker;
execute a supervised learning process for training the AI model for one of an operational event allocation, a business event allocation, a construction event allocation, or a manufacturing event allocation, based at least on training data and the first information that are received from at least one of the second server and a set of terminal devices of the plurality of terminal devices wherein the supervised learning process comprises:
receiving, by the AI model, the training data and the first information, for evaluation from the at least one of the second server and the set of terminal devices, wherein the training data and the first information comprises pre-identified data and unidentified data;
segregating, by the data processing engine, the training data to at least one of content tags, content objects, and the metadata, wherein the unidentified data at least corresponds to the content tags, and the pre-identified data at least corresponds to the content objects and the metadata;
evaluating, invariably, by a propensity calculator of the AI model, the unidentified data for identifying the content tags, based on the pre-identified data;
executing, by an error-minimization module of the AI model, an objective function to compute a degree of error in the identifying the content tags, wherein the propensity calculator outputs data, the error-minimization module receives the output data from the propensity calculator and the training data for executing the objective function, and the error-minimization module outputs second information related to the degree of error to the propensity calculator as feedback; and
changing, invariably, by the AI model, at least a coefficient of the propensity calculator till the degree of error in the identifying the content tags recede a value, wherein the changing of the at least the coefficient of the propensity calculator is based on the feedback from the error-minimization module, and the value is based on the changing of the at least the coefficient of the propensity calculator to minimize the degree of error;
control the trained AI model to optimize, in addition to the supervised learning process, by implementing a machine-readable set of instructions that corresponds to hyperparametric tuning;
determine a resource requirement for the completion of each event of the set of events based on the one or more attributes associated with each event and the metadata related to each worker, wherein the resource requirement indicates a skill required for performing a corresponding event of the set of events, a number of workers required for performing the corresponding event, a time period required for the completion of the set of events, and a tentative date for the completion of the set of events;
acquire the details related to the external factors from the at least one sensor;
control the trained AI model to optimize allocation of the set of events based on the one or more attributes associated with each event, the metadata related to each worker, and the details related to the external factors;
control the trained AI model to generate dynamically a hierarchical structure of the set of events based on the optimized allocation of the set of events and the details related to the external factors, wherein the hierarchical structure indicates planning of a day for each worker, timeframes associated with the completion of each event of the set of events and a location of each event of the set of events;
assign the set of events to at least one worker of the plurality of workers based on the hierarchical structure;
transmit details related to the assigned event to a terminal device of the plurality of terminal devices associated to a corresponding worker of the plurality of workers, wherein the plurality of terminal devices is configured to display the details;
control the trained AI model to receive a request for making changes to the set of events, wherein the supervised learning process is based on the request received for making changes to the set of events, and the first information received from the at least one of the second server and the set of terminal devices corresponds to the request received for making changes to the set of events;
control the trained AI model to update the hierarchical structure based on the request received for making changes to the set of events;
control the trained AI model to re-assign the set of events to the at least one worker based on the updated hierarchical structure;
control the trained AI model to detect the location of each worker of the plurality of workers;
control the trained AI model to monitor a completion status of each event of the set of events; and
control the trained AI model to re-optimize allocation of the set of events based on the re-assign of the set of events, the location of each worker, and the completion status of each event.

13. (canceled)

14. The system according to claim 12, wherein the details related to the assigned event are rendered on a graphical user interface of the terminal device associated to the corresponding worker, and the graphical user interface is configured to display a status of the assigned event.

15. (canceled)

16. The system according to claim 12, wherein the data related to the set of events comprises at least one of a start date of the event, a time period allotted to the event, constraints related to the event, and a difficulty level of the event.

17. The system according to claim 12, wherein the one or more attributes are extracted from the data by parsing the data.

18. (canceled)

19. The system according to claim 12, wherein a dependency defined in the hierarchical structure is maintained.

20. A non-transitory computer readable medium for managing event allocation having stored thereon computer-executable instructions that, when executed by a data processing engine, cause the data processing engine to execute operations, the operations comprising:
acquiring data related to a set of events to be performed from a first server;
identifying one or more attributes associated with each event of the set of events from the data related to the set of events;
acquiring metadata related to each worker of a plurality of workers from a plurality of terminal devices, wherein
the metadata comprises availability of each worker of the plurality of workers, a location of each worker, a strength of each worker, and personal details of each worker,
each of the event includes one of an operational event, a business event, a construction event, or a manufacturing event, and
the AI model is trained for one of an operational event allocation, a business event allocation, a construction event allocation, or a manufacturing event allocation, via a supervised learning process, based at least on training data and first information that are received from at least one of a second server and a set of terminal devices of the plurality of terminal devices, wherein the supervised learning process comprises:
receiving, by the AI model, the training data and the first information, for evaluation from the at least one of the second server and the set of terminal devices, wherein the training data and the first information comprises pre-identified data and unidentified data;
segregating, by the data processing engine, the training data to at least one of content tags, content objects, and the metadata, wherein the unidentified data at least corresponds to the content tags, and the pre-identified data at least corresponds to the content objects and the metadata;
evaluating, invariably, by a propensity calculator of the AI model, the unidentified data for identifying the content tags, based on the pre-identified data;
executing, by an error-minimization module of the AI model, an objective function to compute a degree of error in the identifying the content tags, wherein the propensity calculator outputs data, the error-minimization module receives the output data from the propensity calculator and the training data for executing the objective function, and the error-minimization module outputs second information related to the degree of error to the propensity calculator as feedback; and
changing, invariably, by the AI model, at least a coefficient of the propensity calculator till the degree of error in the identifying the content tags recede a value, wherein the changing of the at least the coefficient of the propensity calculator is based on the feedback from the error-minimization module, and the value is based on the changing of the at least the coefficient of the propensity calculator to minimize the degree of error;
controlling the trained AI model to optimize, in addition to the supervised learning process, by implementing a machine-readable set of instructions that corresponds to hyperparametric tuning;
determining a resource requirement for completion of each event of the set of events based on the one or more attributes associated with each event and the metadata related to each worker, wherein the resource requirement indicates a skill required for performing a corresponding event of the set of events, a number of workers required for performing the corresponding event, a time period required for the completion of the set of events, and a tentative date for the completion of the set of events;
acquiring details related to external factors that affects the completion of the set of events from at least one sensor, wherein the external factors include traffic, weather conditions, supply chain disruption, political instability, natural calamities, road conditions, client availability, vehicle availability, and cost of transportation;
controlling the trained AI model to optimize allocation of the set of events based on the one or more attributes associated with each event, the metadata related to each worker, and the details related to the external factors;
controlling the trained AI model to generate dynamically a hierarchical structure of the set of events based on the optimized allocation of the set of events and the details related to the external factors, wherein the hierarchical structure indicates planning of a day for each worker, timeframes associated with the completion of each event of the set of events and a location of each event of the set of events;
assign the set of events to at least one worker of the plurality of workers based on the hierarchical structure;
transmitting details related to the assigned event to a terminal device of the plurality of terminal devices associated to a corresponding worker of the plurality of workers, wherein the plurality of terminal devices is configured to display the details;
controlling the trained AI model to receive a request for making changes to the set of events, wherein the supervised learning process is based on the request received for making changes to the set of events, and the first information received from the at least one of the second server and the set of terminal devices corresponds to the request received for making changes to the set of events;
controlling the trained AI model to update the hierarchical structure based on the request received for making changes to the set of events;
controlling the trained AI model to re-assign the set of events to the at least one worker based on the updated hierarchical structure;
controlling the trained AI model to detect the location of each worker of the plurality of workers;
controlling the trained AI model to monitor a completion status of each event of the set of events; and
controlling the trained AI model to re-optimize allocation of the set of events based on the re-assign of the set of events, the location of each worker, and the completion status of each event.
